(19) United States
(12) Patent Application Publication
(10) Pub. No.: US 2026/0073362 A1
(43) Pub. Date: Mar. 12, 2026

(54) COOLING TOWER PERFORMANCE MODELING

(71) Applicant: CHEMTREAT, INC., Glen Allen, VA (US)

(72) Inventors: Kevin BOUDREAUX, Sioux Falls, SD (US); John LEWIS, North Wales, PA (US); Timothy S. SWITZER, Midlothian, VA (US); David Craig THOMPSON, Carlsbad, CA (US)

(73) Assignee: CHEMTREAT, INC., Glen Allen, VA (US)

(21) Appl. No.: 19/320,300

(22) Filed: Sep. 5, 2025

Related U.S. Application Data
(60) Provisional application No. 63/691,722, filed on Sep. 6, 2024.

(51) Int. Cl. G06Q 10/20; F28F 27/00

(52) U.S. Cl. CPC G06Q 10/20; F28F 27/003

(57) ABSTRACT

A method for maintaining performance of a cooling tower includes obtaining cooling tower specification information including performance curves indicating a cooling performance of the cooling tower and generating a performance model. The method includes collecting real-time sensor data from the cooling tower, the real-time sensor data including an average inlet water temperature into a condenser and an average outlet water temperature out of the condenser. The method includes calculating a flow rate through the condenser and calculating an expected cold water temperature using the performance model based on (i) a difference between the average outlet water temperature and the average inlet water temperature, (ii) a wet bulb temperature, and (iii) the flow rate. The method includes comparing the expected cold water temperature to the average inlet water temperature to determine a cold water temperature difference, and determining whether the cooling tower requires maintenance based on a calculated production penalty.

### BACKGROUND

Cooling towers provide a crucial function in the power generation process of removing heat from condensed steam that has passed through a turbine, thereby allowing reuse of the cooled water. Conventionally, tracking cooling tower performance relies on single-event spot checks that incur high costs due to complex maintenance requirements and the need for manual inspections.

Another technological problem with conventional methods of performance monitoring of cooling towers is that they are inefficient and fail to provide a comprehensive understanding of performance monitoring. In particular, manually inspecting cooling towers may only reveal individualized problems, such as physical damage to the cooling tower itself. In addition, manual inspection of cooling towers during single-event spot checks does not provide an understanding of the real-time cooling tower performance.

The inventor of this application discovered that existing cooling tower specification sheets include performance curves that can be converted into modeling curves and used in combination with real-time sensor performance data from an operating cooling tower and a condenser to model the performance of the operating cooling tower in a real-time manner. By doing so, the cooling tower performance modeling can be performed on an ongoing basis, thereby providing more accurate modeling results and faster feedback regarding potential maintenance needs.

### SUMMARY

These and other problems are addressed by the disclosed methods, device, and system for maintaining performance of a cooling tower.

One such method includes obtaining cooling tower specification information including performance curves indicating a cooling performance of the cooling tower; generating a performance model based on the performance curves; collecting real-time sensor data from the cooling tower, the real-time sensor data including ambient temperature, ambient humidity, an average inlet water temperature into a condenser, and an average outlet water temperature out of the condenser; calculating a wet bulb temperature based on the ambient temperature and the ambient humidity; calculating a flow rate through the condenser; calculating an expected cold water temperature using the performance model based on a difference between the average outlet water temperature and the average inlet water temperature, the wet bulb temperature, and the flow rate; comparing the expected cold water temperature to the average inlet water temperature to determine a cold water temperature difference; calculating a back pressure penalty based on the cold water temperature difference; calculating a production penalty based on the back pressure penalty; and determining whether the cooling tower requires maintenance based on the production penalty.

One such device includes a processor configured to: collect real-time sensor data from the cooling tower, the real-time sensor data including ambient temperature, ambient humidity, an average inlet water temperature into a condenser, and an average outlet water temperature out of the condenser; calculate a wet bulb temperature based on the ambient temperature and the ambient humidity; calculate a flow rate through the condenser; calculate an expected cold water temperature using a performance model generated based on performance curves indicating a cooling performance of the cooling tower, the performance curves being from cooling tower specification information, and the expected cold water temperature being calculated based on a difference between the average outlet water temperature and the average inlet water temperature, the wet bulb temperature, and the flow rate; compare the expected cold water temperature to the average inlet water temperature to determine a cold water temperature difference; calculate a back pressure penalty based on the cold water temperature difference; calculate a production penalty based on the back pressure penalty; and determine whether the cooling tower requires maintenance based on the production penalty.

One such system includes a cooling tower; and a device for maintaining performance of a cooling tower, the device comprising a processor configured to: collect real-time sensor data from the cooling tower, the real-time sensor data including ambient temperature, ambient humidity, an average inlet water temperature into a condenser, and an average outlet water temperature out of the condenser; calculate a wet bulb temperature based on the ambient temperature and the ambient humidity; calculate a flow rate through the condenser; calculate an expected cold water temperature using a performance model generated based on performance curves indicating a cooling performance of the cooling tower, the performance curves being from cooling tower specification information, and the expected cold water temperature being calculated based on a difference between the average outlet water temperature and the average inlet water temperature, the wet bulb temperature, and the flow rate; compare the expected cold water temperature to the average inlet water temperature to determine a cold water temperature difference; calculate a back pressure penalty based on the cold water temperature difference; calculate a production penalty based on the back pressure penalty; and determine whether the cooling tower requires maintenance based on the production penalty.

### BRIEF DESCRIPTION OF DRAWINGS

FIG. 1 is a diagram of an embodiment of this application.

FIG. 2 is a flow chart of an embodiment of this application.

FIG. 3 is an example of a cooling tower specification sheet with performance curves.

### DETAILED DESCRIPTION OF EMBODIMENTS

In the following description, numerous details are set forth to provide an understanding of the present disclosure. However, it is understood by those skilled in the art that the apparatus and method of the present disclosure may be practiced without these details and that numerous variations or modifications from the described embodiments may be possible.

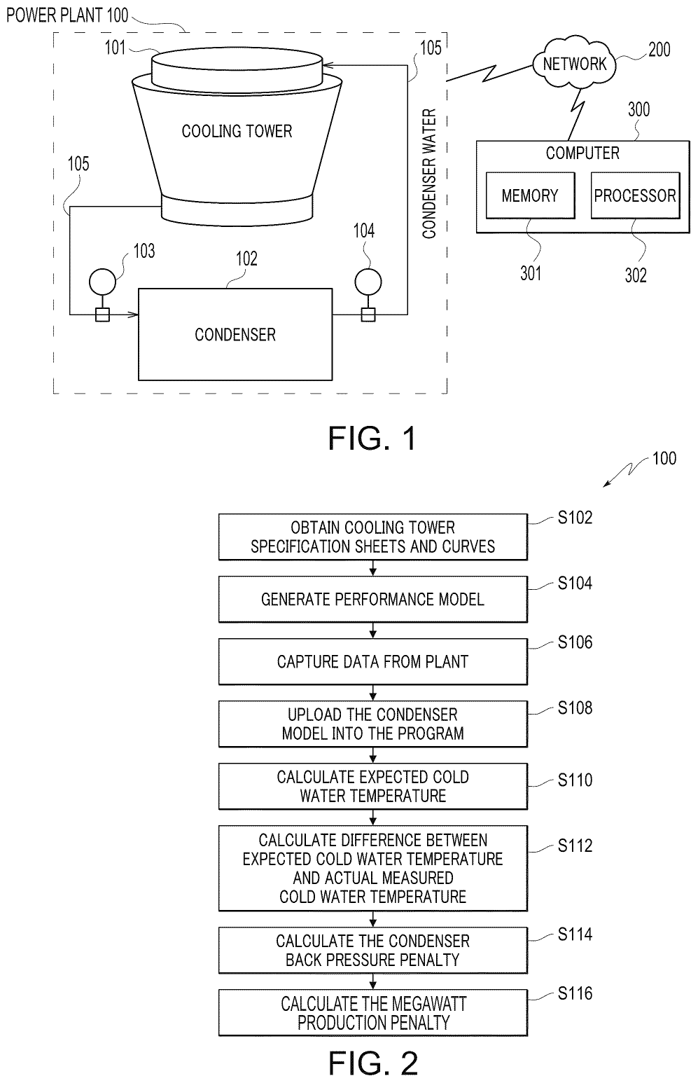

Embodiments of the present disclosure provide a method, a program, and a system for collecting data from a power plant 100 and modeling the performance of a cooling tower 101 at the power plant 100 in order to address maintenance and other efficiency needs. The power plant 100 includes the cooling tower 101 and a condenser 102 connected to the cooling tower via water pipes 105. These and other features are described below in connection with FIGS. 1 to 3.

### (1) Cooling Tower

Cooling towers are structures designed to reduce the temperature of water used in various industrial processes. The tower's evaporative cooling process allows it to efficiently lower the temperature of large volumes of water. Components of the cooling tower 101 contribute to the heat removal process by optimizing water distribution, air-water contact, and evaporation. At the input level, warm water from the industrial process enters the tower at elevated temperatures.

During operation, the cooling tower 101 achieves heat transfer by creating contact between air and water. The efficiency of this process is dependent on the wet bulb temperature of the ambient air, which represents the lowest temperature to which water can be cooled by evaporation in that environment. In operation, the cooling tower 101 processes the warm water through layers of fill material, generating cooled outlet water, and continuously cycling it back to the industrial process. During the cooling process, the tower operates continuously, adjusting to variations in inlet water temperature into the condenser 102, ambient conditions, and cooling demand.

### (2) Explanation of Hardware and Software

Referring to FIG. 1, the cooling tower performance may be modeled using a program stored on a non-transitory computer-readable medium and/or executed by a physical server or circuitry (e.g., a processor 302) of a physical server or other computer. Alternatively, the modeling method may be performed by a cloud server, or virtual circuitry of an abstraction layer of a cloud server, running in a cloud computing environment on the Internet. The modeling method may be performed using the processor 302 and a memory 301. Optionally, the modeling method may include using a display or may, alternatively, include transmitting information and control signals to a display. The memory 301 stores information (for example, programs and various data), and the processor 302 functions based on the information stored in the memory 301. The functions of the processor 302 may be realized by individual hardware or integrated hardware. Also, the processor 302, the memory 301 and the display may be integrated into a computer 300, as shown in FIG. 1. Alternatively, the processor 302, the memory 301 and the display may be partially or completely remotely arranged with respect to each other. For example, the display may be remotely located and connected to the processor 302 via a network 200. The network 200 may include a wireless communication network, the Internet, a VPN (Virtual Private Network), a WAN (Wide Area Network), a wired network, or any combination of these, or the like.

The processor 302 may be, for example, a central processing unit (CPU). However, the processor 302 is not limited to a CPU, and various processors such as a graphics processing unit (GPU) or a digital signal processor (DSP) can be used. The processor 302 may be a hardware circuit based on an ASIC. The term “processor” encompasses both a single processor and multiple processors.

The memory 301 may be a semiconductor memory such as a static random access memory (SRAM) or a dynamic random access memory (DRAM), a register, a magnetic storage device such as a hard disk device, or an optical storage device such as an optical disk device. For example, the memory 301 stores computer-readable instructions, and the processor 302 executes the instructions to realize the function of each part of the apparatus and method. The instructions here may be instructions constituting the program or instructions for the hardware circuit of the processor 302 to perform the method.

The display includes a display device such as a liquid crystal display or an organic EL (electro-luminescent) display. The display can display various images. The display is constituted by, for example, a computer screen, and functions to display data output by the processor 302. The processor 302 may cause the display to output information including display images. Alternatively, the processor 302 may transmit data to another processor which in turn causes the display to output the information including the display images.

The hardware may include sensors for obtaining performance data, including, for example, ambient temperature, ambient humidity, average inlet water temperature of the condenser 102, and average outlet water temperature of the condenser 102. Each is discussed in detail below. For example, the hardware may include thermal sensors, including resistance thermometers (RTDs), thermocouples, or any other sensor suitable for collecting temperature information about the condenser 102 at the power plant 100 or the environment of the condenser 102. The hardware may include thermal probes and humidity probes positioned, for example, at weather stations, for determining the ambient temperature and ambient humidity of the environment of the power plant 100.

### (3) Performance Modeling Method

The performance modeling method includes a plurality of steps of using existing cooling tower performance curves and comparing them to data retrieved from the power plant 100. These steps are discussed below in further detail.

### (3-1) Obtain Cooling Tower Specification Sheets and Performance Curves

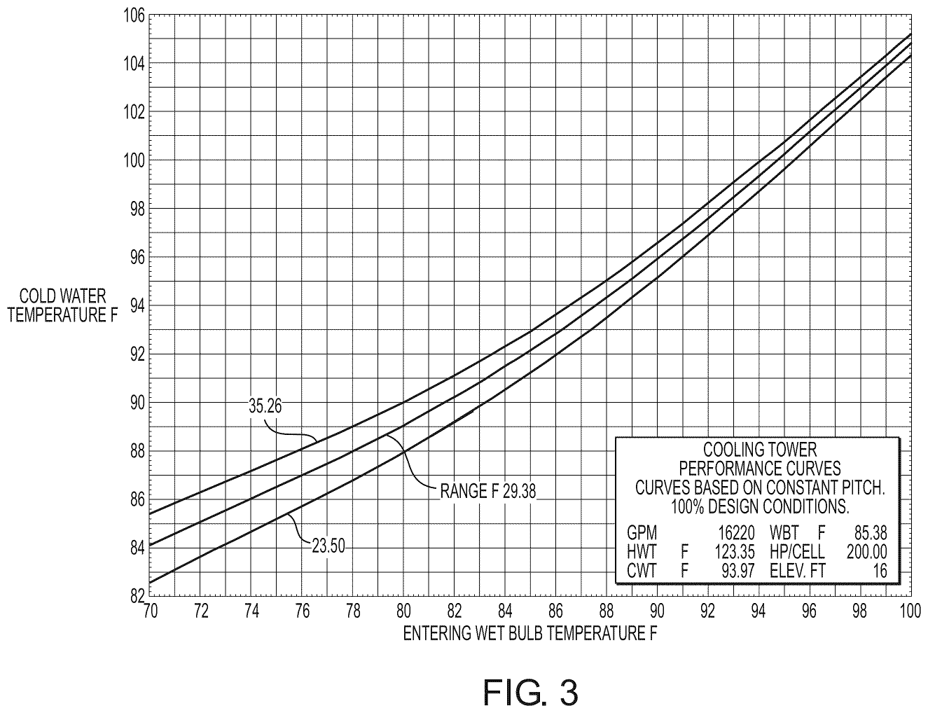

In step S102, the cooling tower specification sheets and performance curves are obtained. The cooling tower specification sheets provide expected performance information of cooling towers under known conditions. Referring to FIG. 3, cooling tower performance curves may be for a given flow rate and cooling water temperature rise through the cooling tower 101 and include the inlet wet bulb temperature on the x-axis and the expected cold water (i.e., inlet water into a condenser) temperature on the y-axis. Cooling tower specification sheets are unique for cooling towers and may be obtained by referring to the cooling tower operations manual for the cooling tower 101.

Referring to FIG. 3, cooling tower specifications include performance curves that predict return cold water temperatures under different wet bulb conditions, cooling water temperature rise, and flow rates of water returning to a condenser 102. Performance curves exist, for example, as tools for evaluating the performance of existing cooling towers.

In step S104 of the method, a performance model is generated. This step includes converting performance curves into equations (performance models) by recording individual data points of the performance model curves. After recording the individual data points of the performance curves, the equations are developed using curve fitting or regression analysis, the equations corresponding to the performance curves. In other words, the (x and y) coordinates of each point on the original performance curve are recorded, and a mathematical formula that satisfies the coordinates of all points on that curve is found.

The equations are a performance model that can use real-time input data from operating cooling towers as an input to calculate expected cold water temperature as an output. As used herein, the term “real-time” means any of continuous, periodic, or batched. For example, “real-time” input data may be data that is continuously received from operating cooling towers, periodically received at predetermined intervals from operating cooling towers, or received in batches that include a back-log of previously collected data from operating cooling towers. Examples of real-time input data may include:
(i) Flow rate: The flow rate is the rate of flow, e.g., in gallons per minute [GPM], at which water flows through the inlet of the condenser 102,
(ii) Delta T (ΔT): ΔT, also known as temperature rise, is calculated as the difference between the average outlet temperature of the recirculating water as it exits condenser 102, and the average inlet water temperature as it enters the condenser 102. The inlet temperature of the cold water entering the condenser 102 is the cold water temperature (basin water) of the cooling tower 101, which is the key performance indicator of the cooling tower operation.
(iii) Wet bulb: The lowest temperature that can be achieved by evaporative cooling. Wet bulb is calculated using the ambient dry bulb temperature, the relative humidity, and the atmospheric pressure while referring to a psychometric chart. A detailed explanation of how the wet bulb is calculated based on these values is omitted as such a calculation is well known to those of ordinary skill in the art.

As discussed above, the input data may be input into the performance model corresponding to the performance curves to calculate an expected cold water temperature. Because this expected cold water temperature is based on the predicted performance of the cooling tower 101, the expected cold water temperature can then be compared to the actual cold water temperature measured at the cooling tower 101. Deviation between these two temperatures (e.g., the actual temperature being higher than expected) may indicate that the cooling tower requires maintenance.

(3-2) Capture Data from Plant

Next, in step S106, data is collected to be entered into the performance model that was calculated in step S104. The data is collected from sensors located at a power plant 100 where the cooling tower 101 and the condenser 102 are located. Specifically, the data may be collected from the above-discussed thermal sensors 103/104. The thermal sensors 103/104 may be located such that they can measure the temperature of water at the inlet of the condenser 102, water at the outlet of the condenser 102, the ambient temperature of the environment of the cooling tower 101, or any other temperature relevant for modeling the performance of the cooling tower 101.

Data may also be collected from sensors to determine the ambient humidity and temperature of the environment of the cooling tower 101. Ambient humidity and temperature information of the cooling tower 101 is obtained from a weather station gathering data for the geographical region associated with the cooling tower 101.

(3-3) Upload Condenser Model into Program

In step S108, the performance model developed in step S104 using curve fitting or regression analysis corresponding to the performance curves may be uploaded into a program, the program being for executing the steps of the method of this application. As discussed above, the program is stored in, for example, a memory 301 in the computer 300, such as a server.

### (3-4) Expected Cold Water Temperature Calculation

In step S110, the program in step S108 is used to calculate expected cold water temperature using the data captured from the plant in step S106. As discussed above, the expected cold water temperature is calculated based on the cooling tower flow rate, the difference between the average outlet temperature of the cold water of the condenser 102 and the average outlet temperature of the cold water of the condenser 102 [ΔT], and the wet bulb at the power plant 100. The calculation of each is discussed in turn below.

The cooling tower flow rate into the inlet of the condenser 102 is calculated by, for example, using the following equation:

$$gpm = \frac{q}{( 500 \times Δ T )} \qquad ( Equation 1 )$$

In the above Equation 1, q is the heat duty (BTU/hr) of the cycle, gpm is the flow rate (gallons per minute) of the cooling water into the inlet of the condenser 102, 500 is a constant factor, and ΔT is the temperature difference between the condenser 102 water outlet and inlet (° F.). The heat duty q is known based on steam flow (lbs/hr) and the latent heat (btus) of that steam. The steam flow rate and the latent heat are known values from operation data of the power plant 100. Thus, by inputting these values and the measured ΔT into the equation, the cooling tower flow rate can be calculated.

The ΔT is calculated by obtaining measurements of the inlet temperature and the outlet temperature at regular intervals to obtain an average inlet temperature and an average supply temperature of the condenser 102. For example, the thermal sensors 103/104 positioned at the inlet and the outlet of the condenser 102 may record temperature data continuously (e.g., every second). This temperature data is stored by and can be retrieved from a memory at the power plant 100. For example, in the method of this application, the temperature data may be retrieved at regular intervals such as every 15 minutes, or at any suitable interval for determining the average temperatures at the inlet and the outlet of the condenser 102. ΔT is then calculated by taking the difference between the average inlet temperature and the average outlet temperature of the condenser 102.

The wet bulb at the cooling tower 101 is calculated based on the ambient temperature at the cooling tower 101, the atmospheric pressure, and the ambient humidity at the cooling tower 101. These values are input into the equations that are developed in step S104 and the output of these equations is the expected cold water temperature.

### (3-5) Comparison of Expected and Actual Cold Water Temperatures

After calculating the expected cold water temperature in step S110, in step S112, the program in step S108 compares the expected cold water temperature to the actual measured cold water temperature at the inlet of the condenser 102. Meaning, the calculated expected cold water temperature is compared to the measured average inlet temperature into the condenser 102 and a difference between these two values may be calculated as the cold water temperature difference (referred to also as CW Temp Diff.). A positive temperature difference indicates that the actual cold water temperature is higher than expected, which may suggest reduced cooling tower efficiency.

### (3-6) Calculating the Back Pressure Penalty

In step S114, the program in step S108 calculates the back pressure penalty using the CW Temp Diff. obtained in step S112. The back pressure penalty refers to the decrease in power plant efficiency due to higher-than-expected condenser pressure (or “back pressure”) caused by suboptimal cooling performance. When the cooling tower 101 does not cool water as effectively as it should, the temperature of the water returned to the condenser 102 is higher than expected. This warmer water leads to higher operating pressure in the condenser 102. Higher condenser pressure (back pressure) reduces the pressure difference across a power generation device (e.g., a turbine) at the power plant 100 that is associated with the condenser 102, which in turn reduces the turbine's efficiency and power output. Back pressure may be calculated using steam tables and is determined by comparing the actual condenser pressure (based on the measured cold water temperature) to the expected condenser pressure (based on the expected cold water temperature). Back pressure may be measured in inches of mercury (inHg). Steam tables are well-known in the art and thus are not explained herein.

As an example, when the calculated CW Temp Diff is elevated by 5° F., it results in a back pressure penalty of about 0.25 inHg. A detailed explanation of how the back pressure penalty is calculated based on an elevation of the cold water temperature difference is omitted as such a calculation is well known to those of ordinary skill in the art.

### (3-7) Calculating Production Penalty and Heat Rate Penalty

In step S116, the production penalty is calculated based on the back pressure penalty calculated in step S114. Generally, this calculation differs for steam turbines depending on the type of power plant, as follows:
In a combined cycle plant, every 1 inHg increase in back pressure results in about 0.50-1.50% efficiency loss.
In a conventionally fired (e.g., coal, oil, or natural gas) plant, it's 1.50-2.50% efficiency loss per 1 inHg.
In a nuclear plant, it's 2.50-3.50% efficiency loss per 1 inHg.

Based on the type of power plant, the calculated back pressure, and the MWhr of power output of the plant, the estimated production penalty may be calculated as a loss in megawatts of production. In other words, the production penalty is the actual loss in power output, measured in megawatts, that results from the efficiency loss caused by increased back pressure due to suboptimal cooling tower performance. The magnitude of this loss in megawatts is used to assess the cooling tower's performance as follows:
1. In response to determining that there is no loss of megawatts, the cooling tower 101 is considered to be performing as expected.
2. In response to determining that there is any loss of megawatts, this may trigger further analysis. Short-term deviations may be due to transient factors such as sudden changes in ambient conditions or plant load. However, persistent loss of megawatts may indicate potential issues with the cooling tower 101, such as fouling of the cooling water, mechanical problems, and the need for maintenance. Such an indication of potential issues with the cooling tower 101 may then trigger sending, as an example, a maintenance alert. The maintenance alert may be displayed on a display as a flashing light or a text based alert. Other examples of triggers are discussed below with regard to control and optimization.
3. The system logs the megawatt loss over time, thereby enabling trend analysis and early detection of gradual performance degradation.

A heat rate penalty of the power plant may also be calculated. The heat rate penalty represents the decrease in efficiency that results from the increased back pressure due to suboptimal cooling tower performance. This increase in heat rate indicates how much more energy input is required to produce the same amount of electrical output and is based on the type of power plant. The magnitude of this heat rate penalty is used to assess the cooling tower's performance similarly as discussed above regarding the production penalty.

### (4) Control and Optimization

The cooling tower performance modeling method described herein not only provides real time information regarding the efficiency and maintenance needs of the cooling tower 101, but can also be leveraged to, in real-time, control and optimize various aspects of power plant operation. When the calculated production penalty indicates an efficiency loss, the system may initiate responses to mitigate the impact. These responses may include potential control action outputs. For example, these control action outputs may be control signals that are sent to a power plant 100 that are used to cause or control the power plant 100 to take a particular action. The following are examples of such actions that may be take in response to a control action being output.
(i) Adjusting cooling tower fan speeds: The system can incrementally increase or decrease fan speeds to optimize the balance between cooling performance and energy consumption in response to a determination of at least one of the loss of megawatts and the heat penalty indicate further analysis.
(ii) Modifying water flow rates: By controlling pumps at the power plant 100, the system can alter the water flow through the cooling tower 101 to achieve optimal heat transfer in response to a determination of at least one of the loss of megawatts and the heat penalty indicate further analysis.
(iii) Initiating cleaning cycles: If the performance degradation suggests fouling or scaling, the system can trigger cleaning processes, such as sending an alert to chemical treatment systems to add biocides to the water of the system. The cleaning process may also include a system that receives a control signal and responds by changing a quantity of biocide (or other suitable power plant cleaning product) that is input into the water of the power plant 100.
(iv) Adjusting condenser load: In response to determining that there are production losses at the power plant 100, the system may adjust the back pressure on the condenser 102, which in turn would reduce the load on the cooling tower, thereby reducing the inlet cold water temperature.

These control actions may be implemented through a series of actuators and control systems connected to the cooling tower performance modeling apparatus directly or via the network 200. The processor 302, upon determining that the production plant has an increase in production losses (e.g., in response to a determination of at least one of the loss of megawatts or the back pressure indicate further analysis), may send a control signal to these systems to initiate the appropriate responses. In other words, in response to determining that the cooling tower 101 requires maintenance, one or more control actions may be initiated in which, for example, the processor 302 controls a device at the power plant 100 to change a parameter of the power plant production process. Furthermore, the system can employ machine learning algorithms to continuously refine its control strategies. By analyzing the outcomes of its interventions, the system can learn which actions are most effective under various operating conditions and environmental factors. This integration of performance modeling with control creates a closed-loop system that not only identifies inefficiencies but actively works to mitigate them in real-time. As a result, power plant operators can maintain efficiency with minimal manual intervention, leading to significant improvements in overall plant performance and reduction in operational costs.

### (5) Technical Advantages

As discussed above, conventional cooling tower performance monitoring methods are technologically problematic due to their reliance on infrequent manual inspections and the inability to provide real-time, comprehensive performance analysis. The cooling tower performance modeling system of this present disclosure solves this problem by, in real-time, analyzing the cooling tower's performance using real-time sensor data and pre-existing performance curves. The system compares expected performance metrics with actual measured data that is received in a real-time manner, thereby providing more accurate and timely assessments of cooling tower efficiency. Thus, unlike conventional monitoring methods, the disclosed cooling tower performance modeling system is able to detect deviations from expected performance and identify potential maintenance needs in real time. In doing so, the system can also adjust for varying operational conditions and environmental factors in a way that conventional monitoring methods are unable to do.

In addition, because the cooling tower performance modeling system calculates and analyzes multiple performance metrics, including expected cold water temperature, condenser back pressure penalty, and megawatt production penalty, it provides a more comprehensive understanding of the impact of the cooling tower 101 on overall power plant efficiency. This multi-faceted analysis allows for more informed decision-making regarding maintenance and operational adjustments, reducing energy waste, and improving plant output. Furthermore, by converting existing performance curves into mathematical equations, the system leverages historical design data in a new way, enhancing the accuracy of its real-time performance predictions. Conventional monitoring methods fail to integrate historical performance data with real-time measurements in this manner, and thus fail to provide the same level of predictive accuracy and comprehensive performance assessment.

Moreover, the cooling tower performance modeling system of this disclosure provides significant advantages through its integration with real-time control systems. By, in real-time, adjusting cooling tower parameters such as fan speeds, water flow rates, and cleaning cycles based on real-time performance data, the system can actively optimize cooling tower efficiency without constant manual intervention. This response capability enhances overall plant performance and minimizes the impact of cooling tower 101 inefficiencies on power production.

In various embodiments, the cooling tower performance modeling can be implemented as a method, a device including the processor 302, or a system. As a computer program product, the invention may take the form of the computer 300 containing the processor 302 configured to perform the described methods.

In another embodiment, the cooling tower performance modeling may be implemented as a system for providing real-time performance modeling of a cooling tower 101. The system may include one or more processors 302 coupled to the memory 301 storing program instructions for performing a modeling process. To gather real-time operational data, the system incorporates a plurality of sensors positioned around the cooling tower 101 and the condenser 102. These sensors include ambient temperature sensors and humidity sensors to monitor environmental conditions that affect cooling tower performance. Additionally, water temperature sensors are positioned at the condenser 102 inlet and outlet to measure the temperature change as water flows through the system. The system may include the network 200 for transmitting information from the various sensors to the one or more processors 302.

The system may include a display device for user interaction and data visualization. For example, the display device could be a monitor that presents performance data, analysis results, or maintenance recommendations.

Stored within the memory 301 are program instructions that can be executed by the one or more processors 302 to perform the cooling tower performance modeling method described above in this disclosure.

The system may be implemented as a standalone device located directly at the power plant 100 for on-site analysis and decision-making. Alternatively, the system can be configured as a distributed system, with some components (such as the sensors) located at the power plant 100, while other components (such at the memory 301 and one or more processors 302) are accessible via the network 200, potentially in a cloud computing environment. This distributed approach enables improved scalability and centralization for monitoring of multiple cooling towers across different locations.

It will be appreciated that the above-disclosed features and functions, or alternatives thereof, may be desirably combined into different systems, apparatuses and methods. Also, various alternatives, modifications, variations or improvements may be subsequently made by those skilled in the art, and are also intended to be encompassed by the disclosed embodiments. As such, various changes may be made without departing from the spirit and scope of this disclosure.

What is claimed is:

1. A method for maintaining performance of a cooling tower, the method comprising:
obtaining cooling tower specification information including performance curves indicating a cooling performance of the cooling tower;
generating a performance model based on the performance curves;
collecting real-time sensor data from the cooling tower, the real-time sensor data including ambient temperature, ambient humidity, an average inlet water temperature into a condenser, and an average outlet water temperature out of the condenser;
calculating a wet bulb temperature based on the ambient temperature and the ambient humidity;
calculating a flow rate through the condenser;
calculating an expected cold water temperature using the performance model based on (i) a difference between the average outlet water temperature and the average inlet water temperature, (ii) the wet bulb temperature, and (iii) the flow rate;
comparing the expected cold water temperature to the average inlet water temperature to determine a cold water temperature difference;
calculating a back pressure penalty based on the cold water temperature difference;
calculating a production penalty based on the back pressure penalty; and
determining whether the cooling tower requires maintenance based on the production penalty.

2. The method of claim 1, wherein the performance curves are converted into the performance model using at least one of curve fitting and regression analysis.

3. The method of claim 1, wherein the real-time sensor data is collected at predetermined intervals of 15 minutes.

4. The method of claim 1, wherein the calculating of the flow rate through the condenser comprises using the equation: gpm=q/(500×ΔT) where q is a heat duty of a heat cycle of the cooling tower, gpm is the flow rate in gallons per minute, 500 is a constant factor, and ΔT is the temperature difference between the condenser water outlet and inlet.

5. The method of claim 1, further comprising logging the calculated back pressure penalty and production penalty over time and tracking trend analysis for detection of gradual performance degradation.

6. The method of claim 1, wherein the calculating of the production penalty comprises:
determining a type of power plant associated with the cooling tower;
determining a loss factor based on the type of power plant; and
calculating the production penalty based on the loss factor and a total power output of the plant.

7. The method of claim 6, wherein the loss factor is: 0.50-1.50% per 1 inHg of back pressure for a combined cycle plant, 1.50-2.50% per 1 inHg of back pressure for a conventional plant, or 2.50-3.50% per 1 inHg of back pressure for a nuclear plant.

8. The method of claim 1, further comprising:
in response to determining that the cooling tower requires maintenance, performing a control action to improve the performance of the cooling tower.

9. The method of claim 8, wherein the control action includes sending a control signal to a power plant associated with the cooling tower, the control signal causing an action to be taken to improve the performance of the cooling tower.

10. A device for maintaining performance of a cooling tower, the device comprising a processor configured to:
collect real-time sensor data from the cooling tower, the real-time sensor data including ambient temperature, ambient humidity, an average inlet water temperature into a condenser, and an average outlet water temperature out of the condenser;
calculate a wet bulb temperature based on the ambient temperature and the ambient humidity;
calculate a flow rate through the condenser;
calculate an expected cold water temperature using a performance model generated based on performance curves indicating a cooling performance of the cooling tower, the performance curves being from cooling tower specification information, and the expected cold water temperature being calculated based on a (i) difference between the average outlet water temperature and the average inlet water temperature, (ii) the wet bulb temperature, and (iii) the flow rate;
compare the expected cold water temperature to the average inlet water temperature to determine a cold water temperature difference;
calculate a back pressure penalty based on the cold water temperature difference;
calculate a production penalty based on the back pressure penalty; and
determine whether the cooling tower requires maintenance based on the production penalty.

11. A system for maintaining performance of a cooling tower, the system comprising:
a cooling tower; and
a device for maintaining performance of a cooling tower, the device comprising a processor configured to:
collect real-time sensor data from the cooling tower, the real-time sensor data including ambient temperature, ambient humidity, an average inlet water temperature into a condenser, and an average outlet water temperature out of the condenser;
calculate a wet bulb temperature based on the ambient temperature and the ambient humidity;
calculate a flow rate through the condenser;
calculate an expected cold water temperature using a performance model generated based on performance curves indicating a cooling performance of the cooling tower, the performance curves being from cooling tower specification information, and the expected cold water temperature being calculated based on (i) a difference between the average outlet water temperature and the average inlet water temperature, (ii) the wet bulb temperature, and (iii) the flow rate;
compare the expected cold water temperature to the average inlet water temperature to determine a cold water temperature difference;
calculate a back pressure penalty based on the cold water temperature difference;
calculate a production penalty based on the back pressure penalty; and
determine whether the cooling tower requires maintenance based on the production penalty.
